(19) United States
(12) Patent Application Publication
(10) Pub. No.: US 2025/0198215 A1
(43) Pub. Date: Jun. 19, 2025

(54) FURNITURE DRIVE FOR DRIVING A MOVABLE FURNITURE PART

(71) Applicant: Julius Blum GmbH, Hoechst (AT)

(72) Inventors: Severin KITZLER, Andelsbuch (AT); Alexander Peterlunger, Lustenau (AT); Klaus Mattle, Koblach (AT)

(21) Appl. No.: 19/070,956

(22) Filed: Mar. 5, 2025

Related U.S. Application Data
(63) Continuation of application No. PCT/AT2023/060301, filed on Aug. 30, 2023.

(30) Foreign Application Priority Data
Sep. 9, 2022 (AT) A 50691/2022

(51) Int. Cl. E05F 15/63; E05F 7/04; E05F 7/06

(52) U.S. Cl. CPC E05F 15/63; E05F 7/04; E05F 7/06; E05Y 2201/648; E05Y 2201/652; E05Y 2900/20

(57) ABSTRACT

A furniture drive for driving a movable furniture part, including a housing, an electric motor, and a bearing device via which the electric motor is mounted in and/or on the housing. The bearing device includes a damping element made of a sound-absorbing material, an actuator, preferably movable back and forth between two end positions, for exerting force on the furniture part to be driven, and a transmission connected between the electric motor and the actuator. A coupling device connects the electric motor, preferably a shaft of the electric motor or a gear connected thereto, to the transmission. The coupling device consists at least partially of a sound-absorbing material, and the housing has a maximum width of less than 18 mm, preferably less than 16 mm.

This application is a continuation of International Application PCT/AT2023/060301 filed on Aug. 30, 2023. Thus, all of the subject matter of International Application PCT/AT2023/060301 is incorporated herein by reference.

### BACKGROUND OF THE INVENTION

The invention relates to a furniture drive for driving a movable furniture part and to a furniture comprising at least one movable furniture part and at least one such furniture drive, wherein the furniture part is movably mounted on the furniture via the at least one furniture drive.

Furniture drives are known from the prior art in which the sound transmission of the noise caused by the electric motor is reduced by mounting the electric motor in and/or on the housing by a bearing device comprising a damping element made of a sound-absorbing material.

This solution has been sufficient so far, since servo motors with a relatively low speed are used as electric motors. At the same time, the furniture drives have a relatively large design and, in the case of flap fittings, are mounted on the flap fittings from the outside and are thus surrounded by air, so that the sound can only propagate relatively difficultly anyway.

In recent years, however, there have been efforts to reduce the design of furniture drives so that they can be installed hidden in a wall of a piece of furniture. On the one hand, this requires the use of other electric motors with a higher speed. On the other hand, the sound can spread better when integrated into a wall. In the worst case, the furniture body acts as a resonance body.

Under these conditions, the noise reduction measures known from the prior art are not sufficient.

### SUMMARY OF THE INVENTION

The object of the present invention is to provide a furniture drive that is improved compared to the prior art and a furniture with such an improved furniture drive, wherein the furniture drive is characterized in particular by a reduced sound transmission of the noise caused by the electric motor.

In the furniture drive, at least one coupling device is thus provided via which the electric motor, preferably a shaft of the electric motor or a gear connected thereto, is connected to the transmission, wherein the coupling device consists at least in regions of a sound-absorbing material.

In this way, the electric motor is completely decoupled from the housing and the drive train: on the one hand from the housing via the bearing device and on the other hand from the drive train via the coupling device. In other words, not only is there a noise decoupling between the motor and the housing, but at the same time there is also a noise decoupling in the drive train. This efficiently reduces the sound transmission of the noise caused by the electric motor.

According to a preferred embodiment, the at least one coupling device comprises a belt, preferably a toothed belt. In this case, the belt can fulfill a dual function: on the one hand, it represents a first stage of the transmission in the gearbox and, on the other hand, the use of a belt provides noise decoupling between the motor and the gearbox.

Alternatively or additionally, at least one coupling device in the form of a gear is used, in which a sound-absorbing material, preferably in the form of an insert, is embedded. In this way, the sound can be decoupled in a gear stage with gears.

The advantages of the present invention are particularly evident in an embodiment in which the at least one electric motor is designed as an external rotor motor or as a disc rotor motor. These motors are characterized by a comparatively flat design. However, these motors also have a high speed and therefore generate more noise, which can be technically compensated for by the invention.

In a particularly preferred embodiment, the at least one bearing device has at least one bearing part connected to the electric motor, and preferably the bearing part is designed as a steel axle, rivet or pin. In this context, it has proven to be advantageous that at least one first damping element and at least one second damping element are arranged on the bearing part. The first damping element reduces sound propagation between the electric motor and the housing in a first spatial direction, and the second damping element reduces sound propagation between the electric motor and the housing in a second spatial direction transverse to the first spatial direction. Preferably, the first and/or the second damping element are designed as a damping disk or damping sleeve. It is advisable to use foamed damping discs and/or damping sleeves in which a steel axle/rivet/pin is inserted. The damping discs can be preloaded via the housing cover and base.

### BRIEF DESCRIPTION OF THE DRAWINGS

Further details and advantages of the invention are explained in more detail below with reference to the drawings, in which:

FIGS. 1, 2 show an item of furniture according to an exemplary embodiment in a perspective view, FIG. 1, and in an exploded view, FIG. 2,

FIG. 3 shows a furniture drive according to an exemplary embodiment without housing cover in a plan view from the side,

FIGS. 4-7 show an assembly comprising the electric motor in a perspective view, FIG. 4, a partial exploded view, FIG. 5, a plan view from above, FIG. 6, a cross-sectional view along the cross-sectional plane 38, FIG. 7, wherein the section 44 is additionally shown enlarged,

FIGS. 8, 9 show a part of the furniture drive comprising the electric motor in a plan view from the side, FIG. 8, and in a cross-sectional view along the cross-sectional plane 43, FIG. 9, wherein the section 45 is additionally shown enlarged, and

FIGS. 10-12 show a coupling device comprising a gear with an insert, wherein FIG. 10 shows a perspective view, FIG. 11 an exploded view and FIG. 12 a cross-sectional view, wherein the section 46 is additionally shown enlarged.

### DETAILED DESCRIPTION OF THE INVENTION

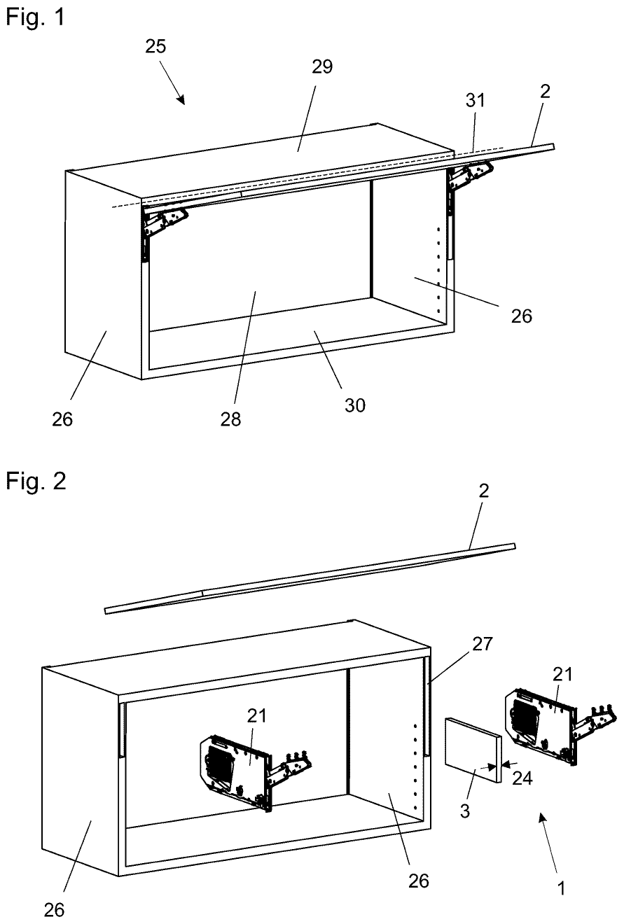

FIGS. 1 and 2 show a furniture 25 in the form of a wall cupboard, comprising a movable furniture part 2 in the form of a flap that can be opened upwards and furniture drives 1, wherein the furniture part 2 is movably mounted on the furniture 25 via the furniture drives 1.

The furniture part 2 can be pivoted about a horizontal axis 31.

The furniture 25 can comprise a rear wall 28, an upper shelf 29 and a lower shelf 30, as in the case shown.

The furniture 25 can comprise walls 26, wherein housings 3, 21 of the furniture drives 1 are each inserted substantially completely into a recess 27 in the walls 26.

The housings 3, 21 preferably have a maximum width 24 of less than 18 mm, preferably less than 16 mm.

An electric motor 4 is arranged in the housing 3, which is only shown schematically in FIG. 2. In particular, the actuator 7, which is connected or connectable to the furniture part, is pivotally arranged on the housing 21.

Not all furniture drives 1 have to be equipped with an electric motor drive unit. In the case shown, only one of the furniture drives 1 has an electric motor drive unit.

Alternative designs of a furniture are conceivable in which the furniture drives according to the invention are used.

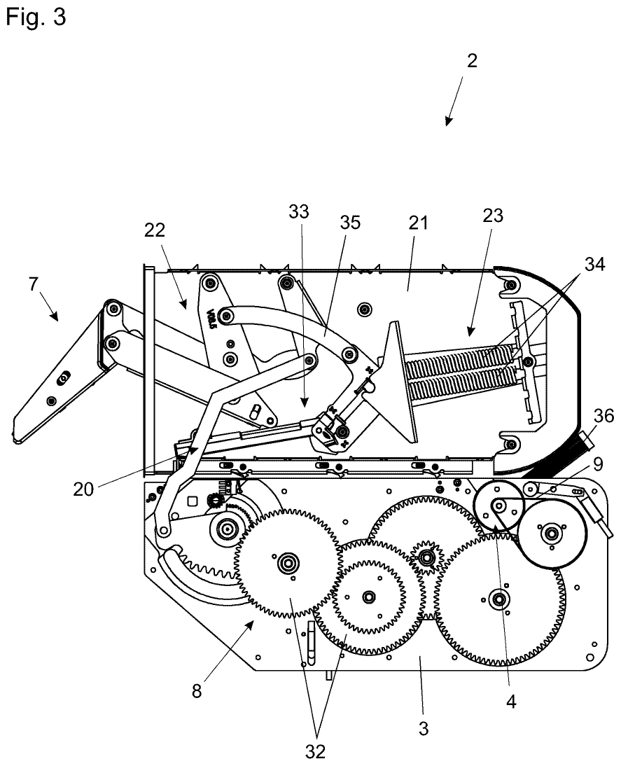

FIG. 3 shows a furniture drive 1 for driving a movable furniture part 2, comprising at least one housing 3, 21, at least one electric motor 4, at least one bearing device 5, via which the electric motor 4 is mounted in and/or on the housing 3, 21, wherein the at least one bearing device 5 comprises at least one damping element 6, 15 made of a sound-absorbing material, at least one actuator 7, which can preferably be moved back and forth between two end positions, for exerting force on the furniture part 2 to be driven, and a transmission 8 connected between the electric motor 4 and the actuator 7, wherein at least one coupling device 9, 10 is provided, via which the electric motor 4, preferably a shaft 11 of the electric motor 4 or a gear 12 connected therewith is connected to the transmission 8, wherein the coupling device 9, 10 consists at least in regions of a sound-absorbing material. Optional details of the bearing device 5 and the coupling device 9, 10 are shown in the following figures.

The electric motor 4 and the transmission 8 can be arranged in a first housing 3, as in the case shown, and the actuator 7 can be arranged in a second housing 21 that is structurally separate from the first housing 3, preferably wherein the two housings 3, 21 are arranged one above the other in a coupled state essentially in a common plane.

At least one transmission device 20 is provided, with which the transmission 8 is connected to the actuator 7, wherein the transmission device 20 comprises at least one lever. Alternative embodiments of the transmission device 20 are also conceivable.

At least one lever arrangement 22 is provided, via which the actuator 7 is pivotally connected to the housing 21. In the specific case, the lever arrangement 22 forms a 7-joint arrangement.

At least one mechanical energy accumulator 23 is provided, with which a force for compensating the weight of the furniture part 2 to be driven can be exerted on the actuator 7. The mechanical energy accumulator 23 can have one or more compression springs 34.

A force transmission lever 35 can be provided to transmit a force stored in the mechanical energy accumulator 23 to the actuator 7.

Furthermore, a force adjustment device 33 can be provided, which can preferably be actuated from a front side of the housing 21 and with which a spring preload of the springs 34 can be adjusted.

In a first end position, which corresponds to a closed position of the furniture part 2, the actuator 7 is arranged essentially completely in the housing 21.

The transmission 8 comprises multiple transmission stages 32, in which an overload and/or a freewheel clutch can also be integrated.

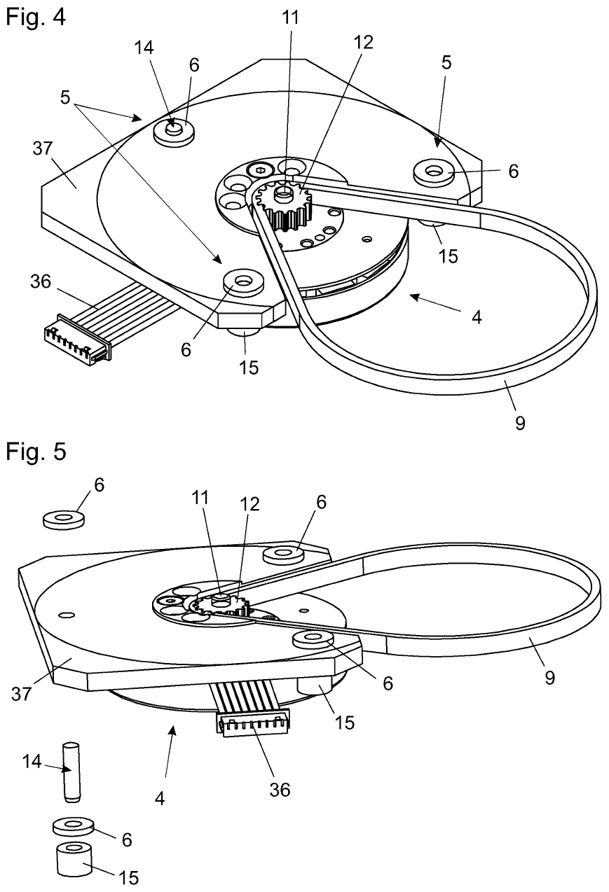

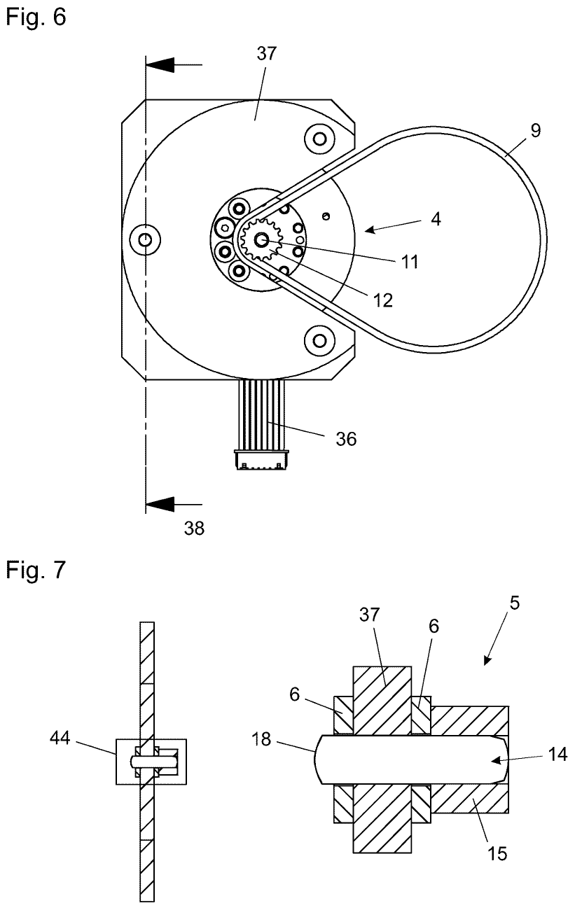

FIGS. 4 to 7 show an assembly comprising the electric motor 4.

In this assembly, the coupling device 9 comprises a belt, which can be designed as a toothed belt, as in the case shown. The belt can have an internal toothing which cooperates with the teeth of the gear 12 arranged on the shaft 11 of the electric motor 4. The internal toothing is not shown in the figures.

The teeth arranged on the inside of the belt can be made of an elastomer. The material used for the teeth can be, for example, rubber, chloroprene rubber, hydrogenated acrylonitrile butadiene rubber or polyurethane plastic.

In the case shown, the at least one electric motor 4 is designed as an external rotor motor. Alternatively, a disc motor can be used. The electric motor 4 can be supplied via power and signal lines 36, and can have a motor flange 37.

The at least one bearing device 5 has at least one bearing part 14 connected to the electric motor 4, wherein the bearing part is designed as a steel axle, rivet or pin. In the specific case, more than one, preferably three, bearing devices 5 are provided, via which the electric motor 4 is mounted in and/or on the housing 3.

The sound-absorbing material of the damping element 6, 15 of the bearing device 5 and/or the coupling device 9, 10 is, for example, a rubber, caoutchouc, or an open-or closed-cell material, preferably a polyurethane elastomer, caoutchouc, silicone, EVA or PE foam.

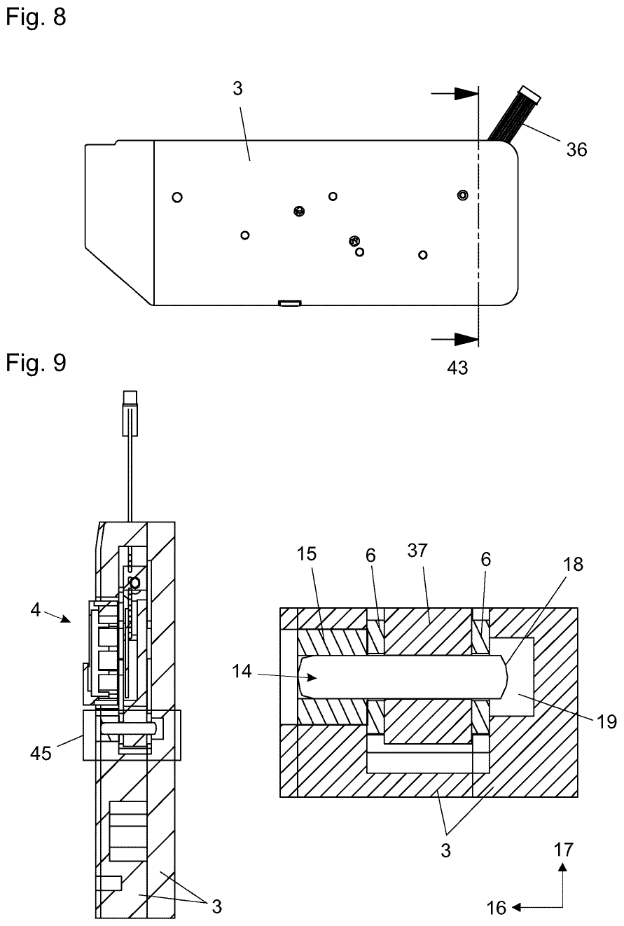

FIGS. 8 and 9 show a part of the furniture drive 1 comprising the electric motor 4.

At least one first damping element 6 and at least one second damping element 15 are arranged on the bearing part 14, wherein the first damping element 6 is arranged in such a way that it reduces sound propagation between the electric motor 4 and the housing 3 in a first spatial direction 16, and the second damping element 15 is arranged in such a way that sound propagation between the electric motor 4 and the housing 3 is reduced in a second spatial direction 17 transverse to the first spatial direction 16, preferably wherein the first and/or the second damping element 6, 15 are designed as a damping disk or damping sleeve.

The bearing device 5 has at least one free end 18, which is arranged in a recess 19 of the housing 3.

The electric motor 4 and the motor flange 37 are not in direct contact with the housing 3 at any point.

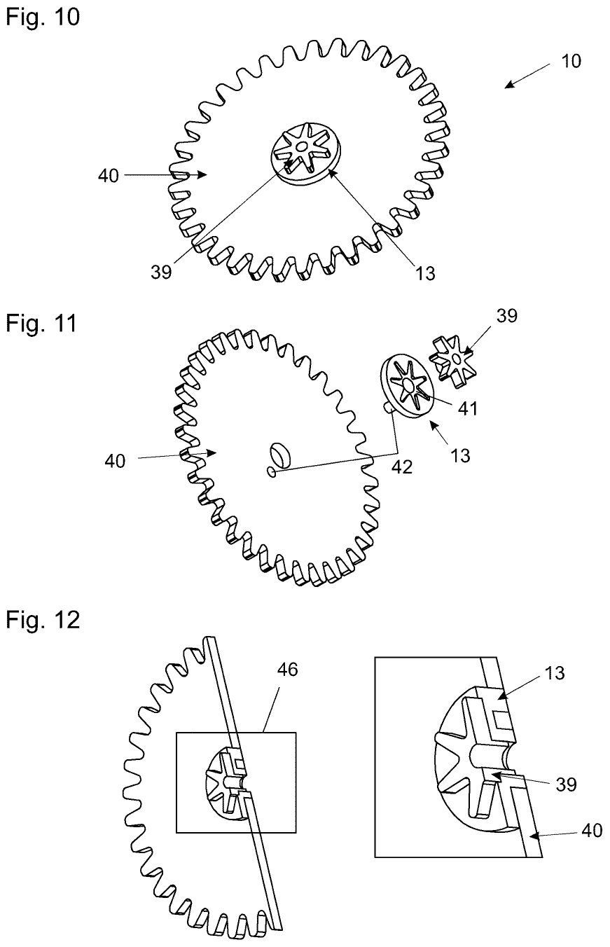

FIGS. 10 to 12 show a coupling device 10 comprising a gear, in which a sound-damping material, preferably in the form of an insert 13, is embedded.

The insert 13 is arranged between a first gear element 39 and a second gear element 40. The first gear element 39 is connected to the insert 13 via a first form-fitting connection 41. The second gear element 40 is connected to the insert 13 via a second form-fitting connection 42. The insert 13 reduces sound transmission between the two gear elements 39 and 40.

The gear can be used, for example, as a first gear stage and/or combined with a belt, as shown in the previous figures.

1. A furniture drive for driving a movable furniture part, comprising:
at least one housing,
at least one electric motor,
at least one bearing device via which the electric motor is mounted in and/or on the housing, wherein the at least one bearing device comprises at least one damping element made of a sound-absorbing material,
at least one actuator, preferably movable back and forth between two end positions, for exerting force on the furniture part to be driven, and
a transmission connected between the electric motor and the actuator,
wherein at least one coupling device is provided, via which the electric motor, preferably a shaft of the electric motor or a gear connected thereto, is connected to the transmission, wherein the coupling device consists at least in regions of a sound-absorbing material.

2. The furniture drive according to claim 1, wherein the at least one coupling device comprises a belt, preferably a toothed belt.

3. The furniture drive according to claim 1, wherein the at least one coupling device comprises a gear into which a sound-damping material, preferably in the form of an insert, is embedded.

4. The furniture drive according to claim 1, wherein the at least one electric motor is designed as an external rotor motor or as a disc rotor motor.

5. The furniture drive according to claim 1, wherein the at least one bearing device has at least one bearing part connected to the electric motor, preferably wherein the bearing part is designed as a steel axle, rivet or pin.

6. The furniture drive according to claim 5, wherein at least one first damping element and at least one second damping element are arranged on the bearing part, wherein the first damping element is arranged in such a way that it reduces sound propagation between the electric motor and the housing in a first spatial direction, and the second damping element is arranged in such a way that sound propagation between the electric motor and the housing is reduced in a second spatial direction transverse to the first spatial direction, preferably wherein the first and/or the second damping element are designed as a damping disk or damping sleeve.

7. The furniture drive according to claim 5, wherein the bearing device has at least one free end which is arranged in a recess of the housing.

8. The furniture drive according to claim 1, wherein more than one, preferably three, bearing devices are provided, via which the electric motor is mounted in and/or on the housing.

9. The furniture drive according to claim 1, wherein the sound-damping material of the damping element of the bearing device and/or the coupling device is a rubber, a caoutchouc, a plastic, or an open-cell or closed-cell material, preferably a polyurethane elastomer, caoutchouc, silicone, EVA or PE foam.

10. The furniture drive according to claim 1, wherein at least one transmission device is provided, with which the gear is connected to the actuator, preferably wherein the transmission device comprises at least one lever.

11. The furniture drive according to claim 1, wherein the electric motor and the transmission are arranged in a first housing and the actuator is arranged on a second housing which is structurally separate from the first housing, preferably wherein the two housings are arranged in a coupled state substantially in a common plane one above the other.

12. The furniture drive according to claim 1, wherein:
at least one lever arrangement is provided, via which the actuator is pivotally connected to the housing, and/or
at least one mechanical energy accumulator is provided, with which a force for compensating the weight force of the furniture part to be driven, can be exerted on the actuator, and/or
the actuator is arranged substantially completely in the housing in a first end position.

13. The furniture drive according to claim 1, wherein the housing has a maximum width of less than 18 mm, preferably less than 16 mm.

14. An item of furniture, preferably an upper cabinet, comprising:
at least one movable furniture part, preferably in the form of a flap that can be opened upwards, and
the furniture drive according to claim 1. wherein the furniture part is movably mounted on the furniture via the at least one furniture drive.

15. The item of furniture according to claim 14, further comprising at least one wall, wherein the housing of the at least one furniture drive is substantially completely inserted into a recess in the wall.
